(19) United States
(12) Patent Application Publication
(10) Pub. No.: US 2018/0168176 A1
(43) Pub. Date: Jun. 21, 2018

(54) SELF-SUPPORTING DAIRY COMPOSITION

(71) Applicant: FrieslandCampina Nederland B.V., Amersfoort (NL)

(72) Inventors: Yves NICOLAS, Wageningen (NL); Diane Margriet DRESSELHUIS, Wageningen (NL); Miranda Maryska Helena HUISMAN, Wageningen (NL)

(73) Assignee: FrieslandCampina Nederland B.V., Amersfoort (NL)

(21) Appl. No.: 15/579,066

(22) PCT Filed: Jun. 3, 2016
(86) PCT No.: PCT/NL2016/050401

§ 371 Date: Dec. 1, 2017

(30) Foreign Application Priority Data
Jun. 5, 2015 (EP) 15170865.8

(51) Int. Cl. A23C 9/154; A23L 29/256; A23L 29/269; A23L 29/281; A23L 33/19

(52) U.S. Cl. CPC A23C 9/1544; A23L 29/256; A23V 2002/00; A23L 29/284; A23L 33/19; A23L 29/272

(57) ABSTRACT

The invention relates to a self-supporting food composition, having a total non-gelatin protein content of 8-15 wt. %, based on the total weight of the composition, at least part of the total non-gelatin protein content being casein, the casein content being 7-13 wt. %, based on the total weight of the composition; the composition comprising 0.2-10 wt. % fat, based on the total weight of the composition; the composition comprising a cold-set gelling agent, in a relative amount of at least 0.3 wt. %, preferably 0.5-5 wt. %, based on the total weight of the composition; the composition comprising water; and the composition having an about neutral pH.

The invention relates to a self-supporting food product comprising a dairy protein, to a mixture suitable for preparing the self-supporting food product and to a method of preparing the self-supporting food product.

Food products comprising dairy protein are well-known nutritious products that are available in various forms and product compositions. The products can be in fluid form (e.g. milk, drink-yoghurt) or an essentially solid form (e.g. cheese), they can be fermented (e.g. yoghurt) or non-fermented, and can be used as part of a full meal (e.g. as dessert or as ingredient of a main course) or as a snack.

US 2002/0031591 relates to a snack food product in the form of resilient, moulded, self-supporting bodies, that are bite-sized. The food product contains a non-gelatin protein (6-36%), at least part of which is dairy protein, gelatin (4.5-12 wt. %) and fat (6-36%). The pH is acidic (4.4-6.2). The products are made using a moulding technique. It is mentioned in the Examples that refrigerated shelf life of a specific product made in accordance with this publication was at least about six months. With respect to shelf life at room temperature, a shelf life of at least about 30 days is mentioned. In view thereof, the present inventors contemplate that the room temperature shelf life of a product made with a method according to US 2002/0031591 is less than three months, especially in tropical of hot regions where the ambient temperatures are high, day-time temperatures usually being above 25° C., like up to 45° C.

US 2010/0316767 relates to a hand-holdable gelled dairy composition comprising gelatin and a live and active culture. In particular, this document relates to yoghurt-based compositions (i.e. acidic compositions).

There is a continuous need for alternative snack foods, in particular for snack foods with a high nutritional value. Snack foods with a relatively high protein content and only a limited amount of fat could provide such alternative with a high nutritional value. Further, there is a continuous need for new products that can be eaten conveniently while hand-held that are appealing to the consumers due to a pleasant organoleptic property (e.g. taste, bite, texture, mouthfeel) and/or its shape. In particular, it would be desirable to provide an alternative over acidic food products (made from a fermented milk component), the alternative having an about neutral pH (typically between pH 6.0 and 7.5).

However, an acidic pH is advantageous over neutral pH in view of microbiological quality, as most pathogenic micro-organisms thrive at about neutral pH, whereas pathological microbial growth is less at acidic pH. A satisfactory microbiological quality becomes even more of a challenge if the water activity of the product is relatively high (>0.8, in particular >0.9). Thus, obtaining satisfactory microbiological quality is in particular a problem with food products that comprise a hydrogel, as these generally have a high water activity (Aw). Further, hand-holdable food products such as described in the above mentioned prior art are made by gelling/setting an aqueous mixture comprising a gelling agent and other ingredients for the food product. pH generally has a significant effect on gelling behaviour, in particular of ionisation of the gelling agent plays a role in the gelling. Moreover, the inventors found that the presence of a high amount of dairy protein is a complicating factor in obtaining a food product with satisfactory properties, especially in an industrial setting.

The inventors tested several aqueous mixtures containing a gelling agent and about 7-12 wt. % milk protein. Products comprising sodium caseinate did not show any satisfactory gelling, and products comprising skimmed milk powder or condensed (evaporated) milk were found to be unsuitable because processing was problematic; a lot of browning was observed and the texture of the resultant product was not satisfactory.

The inventors now found that it is possible to obtain a self-supporting food composition, having an about neutral pH, composed for a substantial part of milk protein (at least 7 wt. %) and water with good organoleptic properties and a satisfactory microbiological quality to allow a relatively long-time storage at room temperature (even in area's where ambient temp is above 25° C., in particular up to 45° C., by preparing the food composition from a specific milk protein source and including a specific type of gelling agent. In particular, they found that a specific aqueous mixture comprising these components can be sterilised by a high temperature treatment without processing problems and that a self-supporting food product can be obtained from such mixture by gelling upon cooling.

In addition, it was found that it is possible to obtain such a self-supporting food composition that is not sticky; lack of stickiness is a desired property for food products, like snack foods. Thus, in an embodiment it can be consumed as finger food without causing sticky fingers. Also, lack of stickiness contributes to a pleasant mouthfeel.

Accordingly, the invention relates to a self-supporting food composition, having a total non-gelatin protein content of at least 8 wt. %, preferably 8-15 wt. %, based on the total weight of the composition, at least part of the total non-gelatin protein content being casein, the casein content being 7-13 wt. %, based on the total weight of the composition;
the composition comprising 0.2-10 wt. % fat based on the total weight of the composition;
the composition comprising a cold-set gelling agent, preferably in a relative amount of at least 0.3 wt. %, preferably 0.5-5 wt. % based on the total weight of the composition; and
the composition having an about neutral pH.

The food composition according to the invention can be consumed as such, or it can form part of a further food product comprising one or more additional phases. Accordingly, the invention further relates to a food product, comprising at least a first phase and optionally one or more further phases, said first phase being a self-supporting food composition according to the invention. A further phase can in particular be another self-supporting gelled composition.

A self-supporting food composition or food product according to the invention can in particular be obtained by processing an aqueous mixture wherein micellar casein is a source for the casein.

Accordingly, the present invention further relates to a method for preparing a food composition or food product according to the invention, comprising
a) providing a fluid aqueous mixture comprising the cold-set gelling agent, the fat and the protein, in which mixture the casein at least substantially consists of micellar casein,
b) introducing the fluid aqueous mixture in a mould
c) gelling the aqueous mixture in the mould thereby obtaining the self-supporting food composition or the food product,
   which method comprises a pasteurization or a sterilization treatment, preferably a pasteurization or a sterilization step carried out during step a), during step b), between steps a) and b) or between steps b) and c).

The invention further relates to an instant (dry) food mixture, suitable for preparing a food composition or food product according to the invention, by dissolving or dispersing the instant food mixture in water.

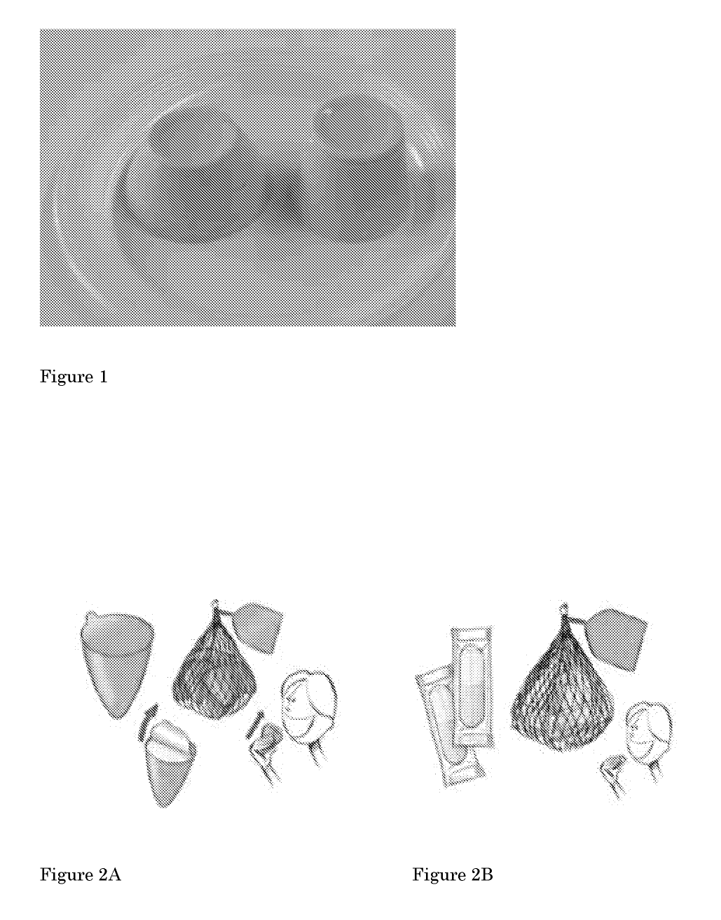

FIG. 1 illustrates food products according to the invention.

FIGS. 2A-2B show examples of packaged food products, illustrating examples of packaging in which food products of the invention can be packaged or from which they can be consumed.

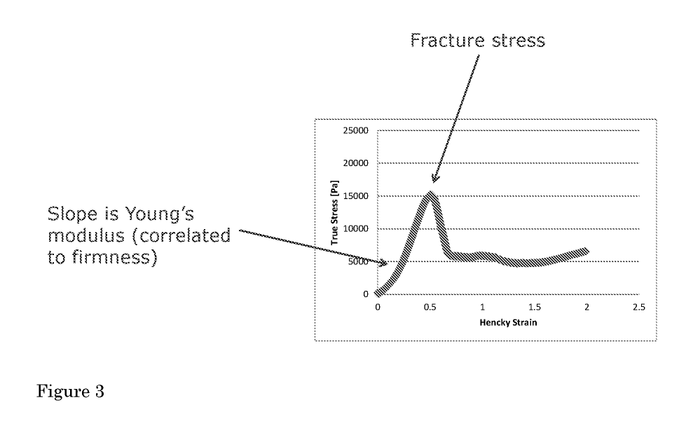

FIG. 3 illustrates how fracture stress and Young's modulus of a food composition or food product can be determined.

As shown in the Examples, by mixing micellar casein and a cold-set gelling agent (plus other ingredients) in water at an (elevated) temperature a fluid mixture is obtained that is adequately sterilised by a ultra high temperature treatment, without processing problems. A self-supporting product is obtained by allowing the product cool down and form a gel, which remains self-supporting at about room temperature. It was possible to provide a product with satisfactory firmness (for which Young's modulus is an indicator) and fracture stress. Firmness is needed for a food composition to be self-supporting. Further, Young's modulus and fracture stress are textural characteristics, amongst others providing an indication of the ‘bite’ of the product and elasticity (Young's modulus). On the other hand, other milk protein sources (e.g. caseinate and products rich in whey protein) caused problems during processing, in particular during heating, e.g. undesired gelling at high temperature, e.g. during pasteurization/sterilization, or formed a product that was not self-supporting at room temperature. In particular compared to vegetable proteins in general, casein is a protein with a high nutritional value (desirable amino acid composition). Also it shows good solubility at about neutral pH, which is advantageous to prepare a food composition with a high protein content according to the invention.

In particular, the invention offers a food composition or product that can be stored at about room temperature for a period of about 3 months or more, in particular for about 4 months or more, e.g. up to 12 months or more, whilst remaining suitable for human consumption, in particular whilst maintaining a satisfactory microbiological quality and whilst maintaining its self-supporting character, at least at 20- 30° C., preferably up to 45° C. or more.

It is further an advantage that the present invention provides a non-fermented self-supporting food composition or food product that can be eaten, e.g. as a snack. Non-fermented food compositions generally have a flavour or other olfactory sensation (e.g. mouthfeel) that is different from a comparable fermented product.

Further, although gelatin can be used as a gelling agent, the invention also offers a gelatin-free composition and product, providing a food product suitable for consumption by vegetarians or by people that adhere to dietary rules in accordance with certain religions that impose restrictions on the consumption of animal products.

Unless defined otherwise, all technical and scientific terms used herein have the same meaning as commonly understood by one of ordinary skill in the art.

The term “or” as used herein means “and/or” unless specified otherwise.
The term “a” or “an” as used herein means “at least one” unless specified otherwise.

The term “substantial(ly)” or “essential(ly)” is generally used herein to indicate that it has the general character or function of that which is specified.

When referring to a quantifiable feature, these terms are in particular used to indicate that it is for at least 75%, more in particular at least 90%, even more in particular at least 95% of the maximum that feature.

The term ‘essentially free’ is generally used herein to indicate that a substance is not present (below the detection limit achievable with analytical technology as available on the effective filing date) or present in such a low amount that it does not significantly affect the property of the product that is essentially free of said substance or that it is present in such a low amount (trace) that it does not need to be labelled on the packaged product that is essentially free of the substance. In practice, in quantitative terms, a product is usually considered essentially free of a substance, if the content of the substance is 0- 0.1 wt. %, in particular 0- 0.01 wt. %, more in particular 0- 0.005 wt. %, based on total weight of the product in which it is present.

The term “about” in relation to a value generally includes a range around that value as will be understood by the skilled person. In particular, the range is from at least 15% below to at least 15% above the value, more in particular from 10% below to 10% above the value, more specifically from 5% below to 5% above the value.

As used herein, percentages are usually weight percentages unless specified otherwise. Percentages are usually based on total weight, unless specified otherwise.

When referring to a “noun” (e.g. a compound, an additive etc.) in singular, the plural is meant to be included, unless specified otherwise.

For the purpose of clarity and a concise description features are described herein as part of the same or separate embodiments, however, it will be appreciated that the scope of the invention may include embodiments having combinations of all or some of the features described.

The term “aqueous” is used herein to describe mixtures with water as only or the major liquid. Generally the water content of an aqueous composition is more than 50 wt. % based on total weight of the liquids (substances that are in the liquid state of matter at 25° C.), preferably 80-100 wt. %, more preferably 90-100 wt. %, in particular 95-100 wt. %.

The term “cold-set gelling agent” is used herein for a substance of which a solution or dispersion in water or an aqueous liquid is non-gelled at a temperature above its setting temperature (which temperature is dependent on the specific gelling agent, but generally above about 20° C., in particular about 30° C. or more, more in particular about 40° C. or more), the product does form a gel when cooled to a temperature below its setting temperature (if present in a sufficient concentration in water or aqueous liquid).

The term ‘self-supporting’ is used herein for matter (such as a substance, composition, product) which essentially remains its shape when put on a horizontal surface without further support from the sides or top of the matter, at least in air, at a pressure of 1 bar, at a temperature of 20°. I.e. the product is not visible fluid. Such matter may also be referred to as self-sustaining matter or dimension-stable matter. Preferably, a food composition according to the invention is self-sustaining at a temperature of 25° C., more preferably at a temperature of 30° C., in particular at a temperature of 35° C., more in particular a temperature of 40° C.

When referred herein to ‘room temperature’, this refers to the ambient temperature in an indoor environment, which is variable depending on the outdoor temperature and indoor temperature control. Usually, room temperature is in the range of 18-30° C., in particular about 25° C. The term ‘ambient temperature’ in general extends not only to indoor ambient temperature but also outdoor ambient temperature, e.g. temperatures that a product or composition may be exposed to during transport, during street-vending etc.

Typically, a self-supporting composition or product according to the invention is firm enough to show fracture, when exposed to a sufficiently high deformation stress, as opposed to shear thinning products, which show only yield or flow when subjected to deformation stress. Usually, the fracture stress of a composition or product according to the invention at 20° C., and preferably also at 30° C., is more than 0.5 kPa, in particular more than 5 kPa, more in particular 15 kPa or more, preferably about 30 kPa or more, more preferably about 60 kPa or more. Usually, the fracture stress at 20° C. (and at 30° C.) is less than 400 kPa, preferably about 250 kPa or less, in particular 150 kPa or less, more in particular about 75 kPa or less. A self-sustaining composition or product also has a measurable Young's modulus. The Young's modulus at 20° C., and preferably also at 30° C., usually is at least 1 kPa, preferably 2-1700 kPa, more preferably 4-1500 kPa.

pH is defined as the apparent pH at 25° C., as measurable by insertion of a standard pH electrode in the medium (fluid or non-fluid) of which the pH is measured, unless specified otherwise. A composition, product, or—after reconstitution in water—instant mixture, according to the invention has an about neutral pH, which is close to the pH of milk. Typically, the pH is in the range of 6.0-7.5, preferably the pH is at least 6.2, more preferably at least 6.3, in particular at least 6.4, more in particular 6.5 or more. Preferably, the pH 7.3 or less, more preferably 7.1 or less, in particular 7.0 or less.

A food composition, food product or instant mixture of the invention comprises protein (molecules and supramolecular structures at least substantially formed of polypeptides). Protein is a nutritional component that is generally considered as highly nutritional, not only as an energy source, but also as a source for amino acids (for anabolism of muscle and other tissue). Within the context of the present invention, gelatin is not considered to be a protein. Thus, when referred herein to “protein”, this excludes gelatin, also when this is not explicitly stated.

The total non-gelatin protein content preferably is at least 9 wt. %, more preferably at least 10 wt. %, in particular at least 11 wt. %. The total non-gelatin protein content generally is 15 wt. % or less, preferably 14 wt. % or less, more preferably 13 wt. % or less, in particular 12.5 wt. % or less. The protein content can be measured by determining the nitrogen content of the protein, using the Kjeldahl methodology (TKN).

Casein is the only or major protein (more than 50% of the total weight of non-gelatin protein) in a composition, product or mixture of the invention. The casein content preferably is at least 8 wt. %, more preferably at least 9 wt. %, in particular at least 9.5 wt. %, more in particular at least 10.0 wt. % of the food product or composition of the invention.

Casein, as found in milk, is a supramolecular association of individual casein subunits: alpha-s1-, alpha-s2-, beta-, and kappa-casein. These fractions are organized within, a micellar structure according to a balance of interactions involving their hydrophobic and hydrophilic groups. The casein micelle is held together by colloidal calcium phosphate. ‘Caseinate’ is a non-micellar protein derived from casein, obtainable by acid precipitation from a liquid containing solubilized casein (casein micelles) such as milk, and subsequent neutralization with a base, such as a hydroxide, e.g. NaOH, KOH, Mg(OH)₂, Ca(OH)₂, NH₄OH or a basic salt, e.g. CaCO₃, Na₂CO₃ or K₂CO₃, and mixtures thereof. Like casein, caseinate is composed of a mixture of four major casein types (alpha S1, alpha S2, beta and kappa casein). However, (micellar) casein contains calcium and phosphate (so-called calcium phosphate clusters) bound to the protein structure, stabilizing the micellar structure. Caseinate does not need to contain calcium nor phosphate, although a caseinate preparation may contain calcium or phosphate. The difference between micellar casein and caseinate can be visualised using electron microscopy; the casein micelles (abundant in e.g. fresh milk) are larger than caseinate clusters.

Preferably, the casein is casein from cow milk. Other suitable sources include milk from other ungulates, in particular milk from hoofed ungulates, such as sheep milk, goat milk, mare, camel and buffalo milk.

A suitable source for the casein component of the present invention is so called MCI, Micellar Casein Isolate. This can be e.g. obtained from FrieslandCampina DOMO, as the product MCI 80 TL product). The composition (wt/wt) has 18.2% dry matter, of which 14.6% protein, lactose 1.8%, minerals 1.4%, fat 0.2%. It can also be obtained in dried form having 96% solids. 89-90% of the total protein in both MCI products is composed of micellar casein.

An example of another protein that may be present in addition to casein is whey protein. The whey protein is usually from the same milk source as the casein. Usually, if present, it is present as residual whey protein in an ingredient used for supplying the casein. Generally the relative amount of whey as a total percentage of milk proteins present in a composition, product or mixture is less than the relative amount as found in the milk from which the casein is obtained. Typically, the weight to weight ratio whey protein to casein 0-0.2, preferably less than 0.15, more preferably about 0.12 or less, in particular about 0.10 or less, more in particular about 0.09 or less. If whey protein is present, the weight to weight ratio whey protein to casein may be 0.01 or more, in particular 0.03 or more, more in particular 0.05 or more.

In a specific embodiment, the cold-set gelling agent comprises a cold-set gelling polypeptide. This is typically a non-dairy polypeptide, such as gelatin.. The gelatin-source is not critical; it usually is from an animal source, in particular from any mammal, e.g. from a cow, sheep, goat, buffalo or other ungulate. It can also be obtained from pigs.

The total cold-set gelling agent content in a food composition according to the invention generally is at least 0.3 wt. %, preferably at least 0.5 wt. %, more preferably at least 0.6 wt. %, in particular at least 0.75 wt. %, more in particular at least 0.9 wt. %. Usually, the total cold-set gelling agent content in a food composition according to the invention is about 5 wt. % or less, preferably 3 wt. % or less, more preferably 2.5 wt. % or less. In particular with polysaccharide cold-set gelling agents, good results have also been achieved at a total cold-set gelling agent content of less than 1.5 wt. %, in particular of about 1 wt. % or less.

The weight to weight ratio of total cold-set gelling agent to casein in a food composition or instant food mixture according to the invention is generally in the range of 0.02-0.71-, preferably in the range of 0.03-0.6, more preferably in the range of 0.04-0.5, in particular in the range of 0.05-0.3.

Good results have been achieved with gelatin. Further, good results have been achieved with cold-set gelling polysaccharides. Such polysaccharide has also been found highly effective at a low concentration; moreover polysaccharidic cold-set gelling agents are generally obtainable from a non-animal source. This is also an advantage if the product should be suitable for vegetarians. Preferred are cold-set gelling gums, such as carrageenan and gellan, preferably low acyl gellan, and agar.

Gellan gum is a hydrocolloid produced by the microorganism Sphingomonas elodea. Gellan gum is manufactured by fermentation. There are two types of gellan gum: high acyl gellan gum, which can be deacylated by treating with alkali to give low acyl gellan gum.

The molecular structure of gellan gum is a straight chain based on repeating glucose, rhamnose, and glucuronic acid units. In its native or high acyl form, two acyl substituents—acetate and glycerate—are present. Both substituents are located on the same glucose residue, and on average, there is one glycerate per repeat and one acetate per every two repeats. In low acyl gellan gum, the acyl groups are removed essentially completely. The properties of the two forms are considerably different. With respect to the use of gellan gum, in particular good results have been achieved with low acyl gellan gum, alone or in combination with high gellan gum.

Further, it is an advantage of such cold-set gelling gums or agar that a composition comprising such a cold-set gelling agent melts at a relatively high temperature, compared to gelatin. This can be advantageous if storage or transport at a relatively high temperature, e.g. at about 35° C. or higher is desired.

Some typical cold set gelling temperatures (or “setting temperatures” or “setting points”) are shown below (° C.):

| | |
|---|---|
| Gelatin: | 30-35 |
| High Acyl gellan: | 70-80 |
| Low Acyl gellan | 30-50 |
| Carrageenan | 20-60, in particular 30-50 |
| Agar | 30-40 |

It is noted that the melting temperature of the cold set gelling agents may lie well above it's setting temperature; this is called hysteresis.

A food composition according to the invention comprises fat. The fat can be any food-grade fat. The fat can be selected from animal fats and vegetable fats. The fat can be liquid or solid at 25° C. The fat can be hardened or not. In particular, the food composition can comprise a fat selected from milk fat (in particular from an ungulate, such as mentioned above for casein) or a fraction thereof, and plant fats or oils, e.g. palm oil, palm kernel oil, rapeseed oil, soy oil, sunflower oil and/or coconut fat. If a product with a relatively low caloric value is desired, it is advantageous that the fat content is relatively low, in particular less than 8 wt. %, more in particular 5 wt. % or less. On the other hand, fatty acids are nutritious and fat has an organoleptic effect that is desired in some embodiments In particular, the fat particle content has an effect on gel properties, such as as fracture properties (stress and strain at fracture). The gel properties also depends of the interactions between fat particles and the gel matrix (formed by the gelling agent): particles can be bound or unbound to the matrix depending on the gelling agent and the (optional) presence of emulsifiers. As a rule of thumb, when fat globules have interaction with the matrix, Young's modulus increases. The fracture strain decreases with increasing oil concentration for droplets bound to the matrix and remains constant for unbound droplets, while the fracture stress is unaffected by bound droplets and decreases in the case of unbound droplets” In order to have an effect on an organoleptic property, in an embodiment, the fat content preferably at least about 2 wt. %.

A food composition according to the invention comprises water. Usually water is the major compound (>50 wt. %) of a composition according to the invention, and a gelled self-supporting food composition according to the invention is a hydrogel. Preferably, the water content is at least 58 wt. %, in particular at least 60, wt. %, more in particular at least 62 wt. %, at least 65 wt. %, at least 68 wt. %, or at least 72 wt. %. An advantage of a relatively high water content is the fact that water has no energetic value. The water content of a food composition according to the invention is less than 92 wt. % usually 91.5 wt. % or less, preferably 91 wt. % or less, more preferably 90 wt. % or less, even more preferably 88 wt. % or less, in particular 85 wt. % or less, more in particular 84 wt. % or less. A food composition or food product according to the invention, typically has a relatively high water activity (Aw), generally of 0.80 or more, in particular of 0.90 or more, more in particular 0.95 or more. The Aw is 1.00 or less, in particular 0.99 or less, more in particular 0.98 or less. The Aw, as used herein, is the value as measured at 25° C., according to AOAC Official Method 978.18.

Optionally, a composition, food product or instant mixture according to the invention comprises one or more thickening agents that are not cold-set gelling agents (at least not in a composition having an about neutral pH, in particular not such composition having a total protein and casein content as in a composition according to the invention). Suitable examples thereof are viscosity enhancing polysaccharides that do not form a gel upon cooling, e.g. starches, locust bean gum, xanthan gum, pectins, guar and celluloses. In an embodiment, the presence of an additional thickening agent contributes to an improved textural characteristic, in particular an improved sensorial effect. Further, in an embodiment, the presence of an additional thickening agent contributes to an improvement with respect to syneresis effect, such as a pro-longed avoidance of noticeable syneresis or a reduced syneresis rate.

Optionally, an emulsifier is added, e.g. a monoglyceride, a diglyceride, or a sugar ester. These can be added in a usual amount, e.g. to facilitate dispersion of the fat in the gel.

A food product or food composition according to the invention may further comprise one or more further food ingredients, in particular one or more ingredients selected from the group of minerals, vitamins, flavours, savoury components, herbs, cacoa, aromas and sugars (e.g. lactose, sucrose, glucose, fructose). It is also possible to add, e.g., a fruit component (e.g. marmalade) or a cereal, like muesli, chocolate.

Usually, the total sugar content is in the range of 0-20 wt. %, preferably in the range of 1-14 wt. %, in particular in the range of 2-8 wt. %, more in particular in the range of 3-6 wt. %. If lactose is present, the lactose content usually is up to 6 wt. %, in particular in the range of 1-5 wt. %.

In addition, the composition of the invention may contain a high intensity sweetener, such as saccharine, aspartame, cyclamate, acesulfame K, sucralose or Stevia. These can be added in a concentration known as such to provide a desired sweetening effect, usually in amounts of up to 0.5 wt. %.

In accordance with the invention, it is possible to obtain a sterile self—supporting food product without unacceptable levels of Maillard browning, also if it contains a substantial amount of sugar. To achieve this, heat-sterilization, such as by UHT or retort, is surprisingly effective.

Advantageously, the food composition is preferably free of added bactericides or added preservatives.

The preparation of a food composition according to the invention generally comprises the provision of a fluid aqueous mixture comprising the cold set gelling agent, the fat, the casein (and optionally other protein) and optionally other ingredient(s). The casein typically at least substantially consists of micellar casein. The preparation of a food composition according to the invention is preferably carried out at about neutral pH.

The fluid mixture is usually provided at a temperature between 20 -70° C., (yet preferably below the denaturation temperature of the protein). The fluid aqueous mixture typically is a fluid mixture containing at least substantially dissolved cold-set gelling agent or a dispersion containing cold-set gelling agent particles (powder). As used herein, particles typically are a cluster of a plurality of molecules and are essentially not dissolved at the temperature of the fluid wherein they are dispersed. The other ingredients may each individually also be dissolved or dispersed in the mixture, when the mixture is provided in step a). A fluid mixture wherein the cold-set gelling agent is already at least substantially dissolved is prepared at a temperature above it setting point. In view of avoiding clogging problems and the like during processing, generally the temperature of the fluid mixture wherein the cold-set gelling agent is at least substantially dissolved is kept above the setting point until after sterilization/pasteurization and until the fluid mixture has been introduced in the mould.

In case the fluid aqueous mixture is a dispersion containing cold-set gel particles, the temperature generally does not need to be above the setting temperature in order to avoid undesired premature gelling. Typically, for substantial gelling the cold-set gelling agent first needs to be dissolved by increasing the temperature above the setting point, and thereafter decreasing the temperature to below the setting point, to allow gellification. Sterilization/pasteurization may be used to dissolve the gelling agent, in particular retort sterilization/pasteurization.

In an embodiment, the fluid aqueous mixture contains dissolved cold-set gelling agent. Such mixture is prepared at a temperature above the gel temperature of the aqueous mixture, to obtain a fluid aqueous mixture wherein at least the cold-set gelling agent is at least substantially dissolved. Once the cold-set gelling agent has been dissolved in an aqueous fluid, it can set to form a gel when reduced to a temperature below the setting temperature of the cold-set gelling agent. In this embodiment, the fluid aqueous mixture is introduced into the mould at a temperature above the setting-point of the mixture in a mould; thereafter, the temperature of the aqueous mixture in the mould to a temperature below the setting point of the mixture, and the aqueous mixture is gelled thereby obtaining the self-supporting food composition or the food product.

In a further embodiment, the fluid aqueous mixture comprising the cold set gelling agent, the fat and the protein is provided as a dispersion, containing dispersed cold-set gelling agent particles. It is not necessary to provide such mixture above the setting point, to avoid premature gelling. In step b), the fluid mixture containing dispersed cold-set gelling agent particles is introduced into the mould, wherein the cold-set gelling agent is then at least substantially dissolved. This can be accomplished by heating, e.g. during sterilization/pasteurisation of the mixture in the mould (retort), or during a separate dissolution step at a temperature above the setting point. The self-supporting food composition or product is formed in step c) comprising adjusting the temperature of the aqueous mixture in the mould to a temperature below the setting point of the mixture.

The setting point (gel temperature) of the aqueous mixture in a method of the invention will usually be in the range of 20-80° C., in particular in the range of 25-65° C., more in particular in the range of 30-60° C. The mould wherein the fluid aqueous mixture is placed can be an industrial mould (disposable or intended for multiple use), typically forming part of a processing line. However, it is also possible to use a container or other packaging as a mould. Thus, the food composition or food product can be formed in the container or other packaging in which it is intended to be offered for sale or distributed or from which it is intended to be consumed.

The fluid aqueous mixture is allowed to cool in the mould to a temperature below the setting point (gelling point), at which it solidifies, to form a self-supporting food composition. It is generally not needed to actively cool the composition, e.g. to a temperature below 20° C., although in principle this is possible.

In order to obtain a sterile food composition or product, one may carry out a method for preparing the food composition or food product under aseptic conditions, starting from sterile ingredients. Another option, is to sterilise the food composition or food product after the formation of the self-supporting food composition or product, e.g. by radiation.

Good results have been achieved with a method to prepare a food composition or food product, wherein the fluid aqueous mixture is subjected to a pasteurisation or sterilisation step. Advantageously, heat-sterilisation or pasteurisation is used.

In a first preferred embodiment wherein heat sterilisation or pasteurisation is used, the fluid aqueous mixture is subjected to a sterilisation step, preferably a UHT treatment, thereafter aseptically introduced into a container or packaging for the composition or product and thereafter gelling the fluid aqueous mixture in the packaging For the purpose of the invention, UHT treatment is generally carried out at 131° C. for 2 minutes or equivalent temperature-time combination to reach an F₀ of at least 12. In a second preferred embodiment wherein heat sterilisation is used, the fluid aqueous is introduced into a container or other packaging for the composition or product, thereafter subjected to a sterilisation step, preferably a retorting step, and thereafter gelling the fluid aqueous mixture in the packaging. For the purpose of the invention, a retorting step is generally carried out at 123° C. for 20 minutes or equivalent temperature-time combination to reach an F₀ of about 10.

The skilled person will be able to determine equivalent temperature-time combinations for a pasteurization or sterilization treatment for reaching a specified Fo on the basis of common general knowledge and the information disclosed herein

An instant food mixture according to the invention can be made by blending the ingredients, e.g. by dry blending at ambient temperature.

From the instant food mixture, a food composition or food product according to the invention is typically made by reconstituting the instant food mixture in hot water (temperature above the setting temperature) in a sufficient amount of water to form a fluid aqueous mixture according to the invention. The fluid aqueous mixture can then be placed in a mould and allow to cool below the setting point, and allowing the aqueous mixture to gel thereby forming the self-supporting food composition. In particular if the food composition is made from the instant food mixture in an industrial setting (not intended for direct consumption), the composition if usually made in a method according to the invention, which comprises a sterilisation or pasteurisation treatment.

The instant food mixture according to the invention usually comprises:
14 to 97 wt. %, in particular 20 to 95 wt. % non-gelatin protein, based on total weight, at least a substantial part of the total protein content being micellar casein, the casein content being 12-95 wt. %, in particular 17.5-90 wt. %, based on the total weight of the composition;
0.3-55 wt. %, in particular 0.4-30 wt. %, more in particular 0.5 to 22.5 wt. % fat, based on the total weight of the composition;
0.5-40 wt. %, in particular 0.6 to 20 wt. %, more in particular 0.75 to 10 wt. % cold-set gelling agent,
   the balance optional ingredients for the self-supporting food composition of the invention, such as mentioned herein.
   The fat in the instant food mixture may be present in particulate form, e.g. as a powder, preferably a spray dried fat powder. Spray dried fat powders are known in the art and comprise spray dried emulsions of fat and an emulsifier.

Preferred percentages for ingredients of the instant food mixture can be derived from the preferred percentages for the self-supporting food composition. In a specific embodiment, the fat content in the instant food mixture is in the range of 5-20 wt. % of the instant food mixture.

In a particularly preferred embodiment, the content of cold-set gelling agent in the instant food mixture is 1.25-7.5 wt. %, more in particular 1.5-5 wt. %.

In a particularly preferred embodiment, the casein content is at least about 30 wt. %, more in particular at least 50 wt. % of the instant food mixture. In a specific embodiment, the casein content is 85 wt. % or less, in particular about 75 wt. % or less of the instant food mixture.

The preparation of a food composition, product or instant mixture of the invention is advantageously free of a substantial acidification step.

Due to the firmness of the food composition according to the invention and the easy processing, allowing the preparation of the composition or product in a mould, which mould can be the final packaging of the product, the invention provides a way to obtain products with various three-dimensional shapes, such as a fantasy figure shape (e.g. of an animal, cartoon, person, flower, vehicle) or a geometrical figure shape (e.g. a bar, a cone, a cylinder, a cube, a ball, a pyramid, a trapezoid). In particular, the invention provides a chewable product.

The food product or food product can be a product for children or a product for adults.

In preferred embodiment, a food product according to the invention is a hand-holdable food product, such that it can be eaten from or by hand, e.g. intended to be offered or consumed as finger food, e.g. a food stick-like product, or can be eaten out of its packaging. In a specific embodiment, the food product is food product for consumption during physical activities, such as sports or during physical work. In a specific embodiment, the food product is for consumption by astronauts.

Thus, the invention, further relates to a packaged food product comprising a food composition according to the invention in a packaging, which packaging preferably is suitable to serve the food from. Preferred packagings are selected from the group of cups, wrappings, cones, tubes, blisters, buckets and pots. Individual pieces of the food product can be packaged separately or in a multi-pack. The packaging, can be of a size suitable for serving to a single person, or for serving to a group of persons (family sized'). The content of the packaging is usually 1000 gram food product or less, in particular in the range of 1-500 g, preferably 5-100 g, more preferably 25-50 g of food product per packaging.

### EXAMPLES

### Determination of Texture Properties (Fracture Stress and Young's Modulus)

In the experiments, the Young's modulus and fracture stress were determined using a texture analyser (TA Stable Microsystems) using a 50 kg load cell. Samples were cylindrical with a diameter of 2.6 cm and average height of 2.7 cm. Samples were compressed with a speed of 5 mm/s (relevant for in mouth sensorial evaluation) until a strain of 0.90, in triplicates, at a constant temperature using a plate (SMS P/75, TA instruments) with a diameter of 7.5 cm. Prior to compression, the sample was covered with silicon oil to avoid buckling.

The true stress/Hencky strain curve was calculated from the resulting data. A typical example of a measured profile is shown in FIG. 3. The Young's modulus was determined over the Hencky strain range 0.2-0.5 (a short linear zone depicting elastic deformation, trend line R²>0.99). The fracture stress is defined as the maximum reached in the stress/strain curve prior to breaking. The Young's modulus is highly correlated with sensorial firmness.

### Example I: Agar as Cold-Set Gelling Agent

Fluid aqueous mixtures were made comprising 10.5 or 11.5 wt. % milk protein, 7.2 wt. % milk fat (from cream or full milk powder) cold-set gelling agent (agar, ROKOAGAR® RGM 900 (Roko)), optionally a further thickening agent, by mixing the milk protein source (skimmed milk powder (SMP), micellar casein isolate (MCI), full fat milk powder, sodium caseinate), milk fat, cold-set gelling agent, and optional further ingredients at a temperature of 50° C. Further, 3.25 wt. % whey permeate powder containing 82 wt. % lactose (Consense 050), was included in the mixtures made with MCI Liquid or sodium caseinate solely to enhance taste. Further, sugar (2 wt. %) and flavour (vanilla), colouring (annatto) were added to the mixtures made with MCI solely to enhance taste.

Thereafter, the fluid aqueous mixtures were subjected to UHT sterilisation, after which the mixtures were introduced aseptically into cups (in those cases wherein the mixtures were still fluid), in which cups were allowed to cool to ambient temperature and gellified to obtain self-supporting food compositions. The UHT conditions were:
Preheating the aqueous fluid mixture to 90° C.;
Heating in the heating section at 131° C. with a holding time of 2 minutes;
Cooling in the first cooling section to 90° C., then to 80° C. in the second cooling section;
Hot Fill (>70° C.) in a mould in an aseptic laminar flow cabinet.
Cool
   Fracture stress and Young's modulus of the self-supporting food compositions were determined at 30° C. as described above.

The following Table shows details on the composition of the various mixtures and the measured Fracture stress and Young's modulus at 30° C.:

| | Milk | | | Thick- | | |
|---|---|---|---|---|---|---|
| | protein | Milk | | ening | Fracture | Young's |
| | content | protein | Agar | agent | stress | modulus |
| Mixture: | [wt. %] | source | [wt. %] | [wt. %] | [kPa] | [kPa] |
| A (ref.) | 11.5 | SMP | 0.63 | — | n.d. | n.d. |
| B (ref) | 10.5 | Full fat | 0.62 | — | n.d. | n.d. |
| | | Milk | | | | |
| | | powder | | | | |
| C (ref) | 11.5 | Sodium | 0.94 | — | 0 | 0 |
| | | caseinate | | | | |
| D | 11.5 | MCI | 0.62 | — | 17.2 | 80 |
| E | 11.5 | MCI | 0.46 | 0.23¹ | 11.6 | 66 |

¹locust bean gum
n.d.: not measurable due to clogging problems

The mixture A, made with SMP, was found to give rise to processing problems and excessive Maillard browning. The texture was different (grainy) from the texture of the products made with MCI (not grainy).

The mixture B, made with milk powder, was found to result in clogging in the UHT equipment.

Mixture C did not form a gel; no self-supporting product was obtained.

Mixtures D and E, made with MCI had all satisfactory processing properties and resulted in self-supporting products when cooled to ambient temperature (about 25° C.).

### Example II: Low-Acyl Gellan as Cold-Set Gelling Agent

An aqueous mixture (G) according to the invention was made, by mixing the following ingredients at a temperature of 50° C.: 77.00% MCI liquid, 17.13% cream, 3.25% Consense 050, 0.77% low-acyl gellan (Kelcogel F (CP Kelco)), 2.00% sucrose, flavours (vanilla), colouring (annatto). The obtained fluid mixture contained 11.5 wt. % protein (micellar casein) and 7.2 wt. % fat.

The aqueous mixture was UHT treated to obtain a sterile mixture and filled into a cup, in which it was allow to cool to 30° C., under formation of a gelled, self-supporting food product.

The fracture stress at 30° C. was 67.1 kPa, the Young's modulus at 30 C was 1478 kPa.

A reference mixture (H), containing the same concentration of low-acyl gellan with were made using a mixture of SMP and full cream milk powder (in a ratio of about 1:2) in water at a protein content of 9.5 wt. % and a fat content of 6 wt. %, instead of MCI. The mixtures caused clogging in the UHT equipment.

Another reference mixture (I) was made with concentrated milk (full fat EVAP, concentration factor of about 1.8) and 0.84 wt. % low-acyl gellan. This mixture also already caused clogging during UHT treatment at a relatively low protein concentration (6.7 wt. % protein, of which 80wt. % casein).

Replacement of the MCI by sodium caseinate (mixture J; 11.5 wt. % protein, 7.2 wt. % fat) resulted in an aqueous mixture that did not form a gelled product, also if the low-acyl gellan content was increased to 1.1 wt. %

Further, a reference mixture (K) was made from 33.3 wt. % skimmed milk powder, 16.65 wt. % cream, 0.78 wt. % low-acyl gellan, in water. This mixture content 11.5 wt. % protein (whey protein and casein) and 7.2 wt. % fat. Processing was problematic (clogging of the equipment); there was excessive browning and the texture was distinct (grainy) from the textures obtained with MCI (not grainy).

### Example III: products comprising high-acyl gellan

Aqueous mixtures (K, L) according to the invention was made, by mixing the following ingredients at a temperature of 50° C.: 77.00% MCI liquid, 17.13% cream, 3.25% Consense 050, gellan (high-acyl (CP Kelco: Kelcogel HM-B [N]) or mixture of high-acyl and low-acyl gellan (low-acyl: Kelcogel F (CP Kelco)), 2.00% sucrose, flavours (vanilla), colouring (annatto). The obtained fluid mixtures contained 11.5 wt. % protein (of which 90% micellar casein) and 7.2 wt. % fat. The liquid mixtures were UHT-sterilised, introduced into a mould and allow to cool down to about 30° C. to obtain a self-supporting food products according to the invention.

| | High-acyl | Low-acyl | Fracture | Young's |
|---|---|---|---|---|
| Mixture | gellan [wt. %] | gellan [wt. %] | stress | modulus |
| K | 0.77 | 0 | 0.6 | 0.6 |
| L | 0.46 | 0.16 | 7.4 | 49 |

Of these two products, the product comprising both high and low acyl gellan (L) has favourable self-supporting properties, because of its higher firmness and fracture stress. Product K, only comprising 0.77 wt. % high-acyl gellan as cold-set gelling agent, is considered to have too low self-supporting for use/storage at relatively high temperature.

### Example IV

Example III was repeated, but with 2.33 wt. % gelatin (Beef skin gelatin from Gelnex Industria e comercio) instead of the gellan(s). A self-supporting food product (N) was obtained. The product was stored at 4° C. for three months. Thereafter, fracture stress and Young's modulus were determined at 10° C. and at 30° C.:

| Temperature [° C.] | Fracture stress [kPa] | Young's modulus [kPa] |
|---|---|---|
| 10 | 41 | 78 |
| 30 | 4 | 7 |

### Example V

Self-supporting food products were made using carrageenan (Satiagel™ ADG 14 (Cargill) kappa/iota type) as a cold-set gelling agent. Several aqueous mixtures were made at a temperature of 50° C., UHT-treated, introduced in cups and cooled down to allow the mixtures to gel, forming self-supporting products (dimension-stable at 30° C.).

| | Mix O | Mix P | Mix Q | Mix R | Mix S | Mix T |
|---|---|---|---|---|---|---|
| Recipe: | | | | | | |
| MCI liquid | 78.4 | 78.4 | 76.2 | 78.4 | 78.4 | 78.4 |
| cream | 4.6 | 4.6 | 4.6 | 20.2 | 4.6 | 4.9 |
| Consense 050 | 0 | 0 | 0 | 0 | 3.25 | 0 |
| Carrageenan | 0.75 | 0.75 | 0.90 | 0.75 | 0.75 | 0.75 |
| Added water | 16.2 | 13.5 | 13.,3 | 0 | 12.9 | 4.0 |
| Product | | | | | | |
| composition: | | | | | | |
| Protein content | 11.5 | 11.5 | 11.5 | 11.5 | 11.5 | 11.5 |
| (wt. %) | | | | | | |
| casein: | 10.3 | 10.3 | 10.3 | 10.3 | 10.3 | 10.3 |
| Lactose | 4.0 | 1.4 | 1.4 | 1.8 | 4.0 | 1.4 |
| Fat | 2.1 | 2.1 | 2.1 | 8.7 | 2.1 | 2.1 |
| carrageenan | 0.75 | 0.75 | 0.90 | 0.75 | 0.75 | 0.75 |

The table above shows that it is passible to produce a variety of products using different ingredients without loosing the self sustaining characteristics of the product according to the invention. The possibility to use ingredients like sugars, fat and minerals (from the whey protein concentrate in varying concentration provides the possibility to formulate products.

1-15. (canceled)

16. A self-supporting food composition having an about neutral pH, comprising:
(a) 8-15 wt. % of a total non-gelatin protein content, based on the total weight of the composition, wherein 7-13 wt. %of the total non-gelatin protein content is casein, based on the total weight of the composition;
(b) 0.2-10 wt. % fat, based on the total weight of the composition;
(c) at least 0.3 wt. % of a cold-set gelling agent, based on the total weight of the composition, and
(d) water.

17. The food composition according to claim 16, comprising 0.5-5 wt. % of the cold-set gelling agent, based on the total weight of the composition.

18. The food composition according to claim 16, wherein the cold-set gelling agent comprises at least one one cold-set gelling polypeptide and/or at least one cold-set gelling polysaccharide.

19. The food composition according to claim 16, wherein the cold-set gelling polypeptide is gelatin and/or the cold-set gelling polysaccharide is selected from the group consisting of gellan, agar and carrageenan.

20. The food composition according to claim 16, having a water activity coefficient (Aw) of 0.80-1.00 (at 25° C., as measured with AOAC Official Method 978.18).

21. The food composition according to claim 20, having a water activity coefficient (Aw) of 0.90-1.00 (at 25° C., as measured with AOAC Official Method 978.18).

22. The food composition according to claim 16, wherein the pH (at 25° C., as determined by inserting a pH electrode in the composition and measuring the pH) is in the range of 6.0-7.5.

23. The food composition according to claim 22, wherein the pH (at 25° C., as determined by inserting a pH electrode in the composition and measuring the pH) is in the range of 6.3-7.0.

24. The food composition according to claim 16, having a water content of 58- 91.5 wt. %.

25. The food composition according to claim 24, having a water content of 65-90 wt. %.

26. The food composition according to claim 16, having a ratio of whey protein to casein of 0 to 0.15.

27. The food composition according to claim 26, having a ratio of whey protein to casein of 0.01 to 0.11.

28. The food composition according to claim 16, having a fracture stress at 20° C. and/or at 30° C. in the range of 5-400 kPa.

29. The food composition according to claim 28, having a fracture stress at 20° C. and/or at 30° C. in the range of 60-250 kPa.

30. The food composition according to claim 16, having a Young's modulus at 20° C. and/or at 30° C. in the range of 1-1700 kPa.

31. The food composition according to claim 16, further comprising a thickening agent, other than the cold-set gelling.

32. The food composition according to claim 31, wherein the thickening agent is selected from the group consisting of starches, locust bean gum, guar gum, xanthan gum, pectins and celluloses.

33. An instant food mixture for preparing a composition according to claim 16, comprising:
(a) 14 to 97 wt. % of non-gelatin protein, based on total weight, at least a substantial part of the total protein content being micellar casein, the casein content being 12-95 wt. %, based on the total weight of the composition;
(b) 0.3-55 wt. % fat, based on the total weight of the composition; and
(c) 0.5-40 wt. %,of a % cold-set gelling agent.

34. A method for preparing a food composition or food product according to claim 16, comprising
(a) providing a fluid aqueous mixture comprising the cold-set gelling agent, the fat and the protein, in which mixture the casein at least substantially comprises micellar casein,
(b) introducing the fluid aqueous mixture in a mould, and
(c) gelling the aqueous mixture in the mould thereby obtaining the self-supporting food composition or the food product,
wherein the method further comprises a pasteurization or a sterilization treatment.

35. The method according to claim 34, wherein the fluid aqueous mixture is subjected to a UHT treatment, and thereafter (i) aseptically introduced into the mould at a temperature above the gel setting point of the mixture, and (ii) its temperature reduced to a temperature below the setting point and the fluid aqueous mixture is gelled in the mould, thereby forming the composition or product.
